(19) United States
(12) Patent Application Publication
(10) Pub. No.: US 2008/0198308 A1
(43) Pub. Date: Aug. 21, 2008

(54) DISPLAY PANEL AND DISPLAY APPARATUS HAVING THE SAME

(75) Inventors: Jae-Ho LEE, Cheonan-si (KR); Kye-Hun LEE, Cheonan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/933,356

(22) Filed: Oct. 31, 2007

(30) Foreign Application Priority Data
Feb. 16, 2007 (KR) 10-2007-0016455

(51) Int. Cl. G02F 1/1335

(52) U.S. Cl. 349/106; 349/110; 349/96

(57) ABSTRACT

A display panel includes first black matrix and a second black matrix to block light, and color filters to display a color image. The first black matrix corresponds to a light blocking area, and the color filters correspond to a light transmission area. The second black matrix is arranged in the light transmission area to divide the transmission area into at least two sub-areas. The light transmission area of the display panel is arranged differently than the light transmission area of a prism sheet and a polarizing plate.

### CROSS-REFERENCE TO RELATED APPLICATION

This application claims priority from and the benefit of Korean Patent Application No. 10-2007-0016455, filed on Feb. 16, 2007, which is hereby incorporated by reference for all purposes as if fully set forth herein.

### BACKGROUND OF THE INVENTION

1. Field of the Invention

The present invention relates to a display panel and a display apparatus having the same. More particularly, the present invention relates to a display panel capable of improving display quality, and a display apparatus having the same.

2. Discussion of the Background

In general, a liquid crystal display apparatus includes a liquid crystal display panel for displaying an image, and a backlight assembly for providing light to the liquid crystal display panel.

A liquid crystal display panel includes an array substrate, a color filter substrate facing the array substrate, and a liquid crystal layer interposed between the array substrate and the color filter substrate. The array substrate includes pixels, which are basic elements for representing an image. Each pixel may include a thin film transistor and a pixel electrode. The thin film transistor receives a pixel voltage and provides the pixel voltage to the pixel electrode. The pixel electrode is connected to a drain electrode of the thin film transistor, and faces a common electrode arranged on the color filter substrate, with the liquid crystal layer interposed therebetween. The color filter substrate includes color filters arranged corresponding to the pixels, and a black matrix surrounding each color filter. The black matrix blocks light from the backlight assembly. Thus, the liquid crystal display panel is divided into a light transmission area through which the light passes and a light blocking area in which the light is blocked.

In addition, a prism sheet of the backlight assembly has a light transmission area and a light blocking area defined by peaks and valleys of prisms arranged on the prism sheet. Additionally, a polarizing plate arranged on an upper side of the liquid crystal display panel has both a light transmission area and a light blocking area defined by beads of an anti-reflective layer arranged on the upper surface of the polarizing plate to prevent scattered reflection. However, the light transmission area and the light blocking area of the prism sheet, the light transmission area and the light blocking area of the polarizing plate, and the light transmission area and the light blocking area of the liquid crystal display panel may not be arranged to minimize optical interference. Therefore, optical interference occurs among the prism sheet, the polarizing plate and the liquid crystal display panel. Moreover, a moire phenomenon and a defect in which certain pixels in the liquid crystal display panel are observed as a white point may occur.

### SUMMARY OF THE INVENTION

This invention provides a display panel capable of improving display quality.

The present invention also provides a display apparatus including the display panel capable of improving display quality. [

Additional features of the invention will be set forth in the description which follows, and in part will be apparent from the description, or may be learned by practice of the invention.

The present invention discloses a display panel including a substrate including pixel areas, each pixel area including a light transmission area and a light blocking area, a color filter arranged in the pixel area, a first black matrix arranged in the light blocking area to block the light, and a second black matrix arranged in the light transmission area to block the light, the second black matrix dividing the light transmission area into at least two sub-areas.

The present invention also discloses a display apparatus including a display panel to display an image using a light and a backlight assembly to provide the light to the display panel. Further, the display panel includes a substrate including a plurality of pixel areas, each pixel area including a light transmission area and a light blocking area, a color filter arranged in the pixel area, a first black matrix arranged in the light blocking area to block the light, and a second black matrix arranged in the light transmission area to block the light, the second black matrix dividing the light transmission area into at least two sub-areas.

The present invention also discloses liquid crystal display (LCD) apparatus including an LCD panel, a first polarizing member arranged on a first surface of the LCD panel, a second polarizing member arranged on a second surface of the LCD panel, and a backlight assembly including a light source and a prism sheet. Further, the LCD panel includes an array substrate including a gate line, a data line, and a thin film transistor connected to the gate line and the data line to provide a pixel voltage to a pixel electrode, a color filter substrate including a common electrode and a pixel area, the pixel area including a light transmission area and a light blocking area, a liquid crystal layer interposed between the array substrate and the color filter substrate, a color filter arranged in the light transmission area, the color filter being a red color filter, a green color filter, or a blue color filter, a first black matrix surrounding the color filter and arranged in the light blocking area to block the light, and a second black matrix arranged in the light transmission area to block the light, the second black matrix dividing the light transmission area into a first sub-area and a second sub-area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view illustrating a liquid crystal display panel according to an exemplary embodiment of the present invention.

FIG. 2 is a section view taken along line I-I′ shown in FIG. 1.

FIG. 3 is a plan view illustrating a color filter substrate shown in FIG. 2.

FIG. 4 is a plan view illustrating a color filter substrate according to another exemplary embodiment of the present invention.

FIG. 5 is a plan view illustrating a color filter substrate according to another exemplary embodiment of the present invention.

FIG. 6 is a plan view illustrating a color filter substrate according to another exemplary embodiment of the present invention.

FIG. 7 is a section view illustrating a liquid crystal display apparatus having the liquid crystal display panel shown in FIG. 1.

FIG. 8 is a perspective view illustrating the prism sheet shown in FIG. 7.

FIG. 9 is a section view taken along line II-II′ shown in FIG. 8.

FIG. 10 is a plan view illustrating the first polarizing plate shown in FIG. 7.

FIG. 11 is a section view taken along line III-III′ shown in FIG. 10.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Hereinafter, exemplary embodiments of the present invention will be explained in detail with reference to the accompanying drawings.

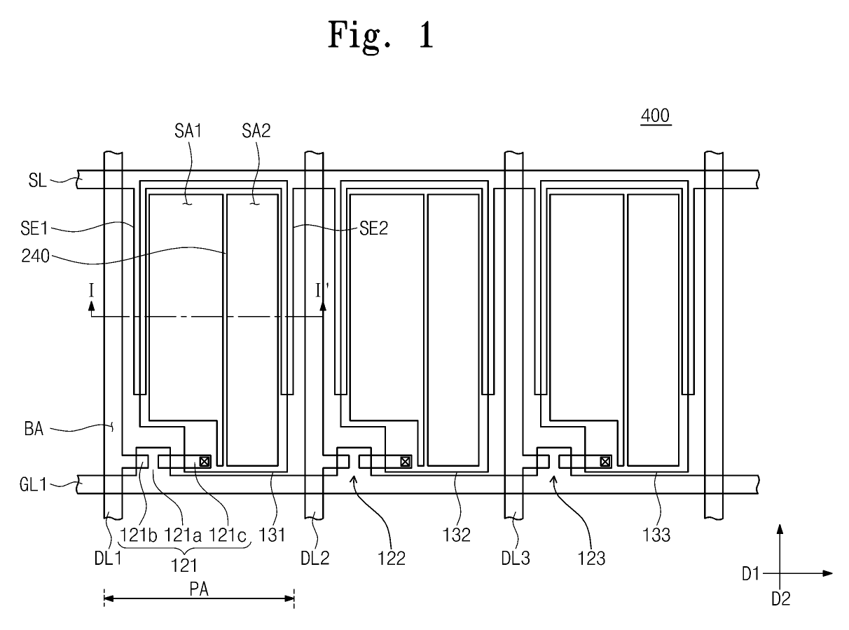

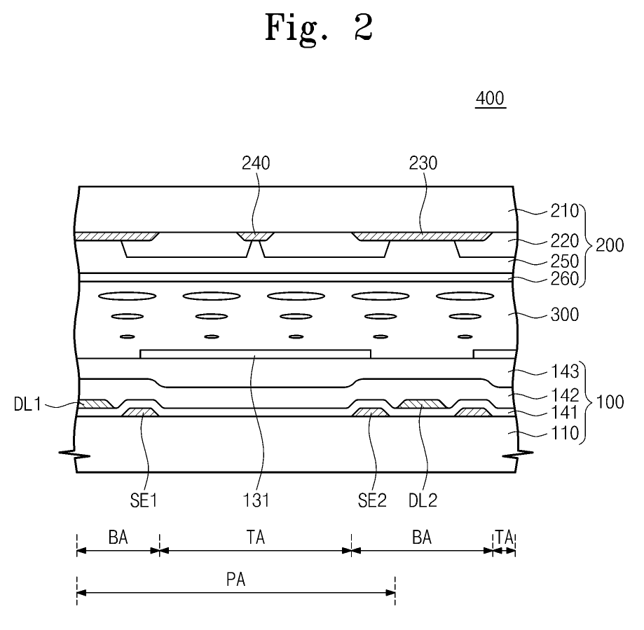

FIG. 1 is a plan view illustrating a liquid crystal display panel according to an exemplary embodiment of the present invention, and FIG. 2 is a section view taken along line I-I′ shown in FIG. 1.

Referring to FIG. 1 and FIG. 2, the liquid crystal display panel 400 includes an array substrate 100, a color filter substrate 200, and a liquid crystal layer 300.

The array substrate 100 includes a first base substrate 110, gate lines including a first gate line GL1, data lines including a first data line DL1, thin film transistors 121, 122, and 123, and pixel electrodes 131, 132, and 133.

Pixel areas PA on which an image is displayed are defined on the first base substrate 110. Each pixel area PA includes a light transmission area TA, and a light blocking area BA that surrounds the light transmission area TA and blocks the light.

The gate lines including the first gate line GL1 extend in a first direction D1 in the light blocking area BA to transmit gate signals. The data lines including the first data line DL1 extend in a second direction D2 substantially perpendicular to the first direction D1 in the light blocking area BA to transmit data signals. The data lines including the first data line DL1 are insulated from the gate lines including the first gate line GL1 while crossing with the gate lines including the first gate line GL1, and define the pixel areas PA in combination with the gate lines including the first gate line GL1.

The thin film transistors 121, 122, and 123 and the pixel electrodes 131, 132, and 133 are arranged on the first base substrate 110 in correspondence with the pixel areas PA, respectively. Each thin film transistor is connected to a corresponding gate line, a corresponding data line, and a corresponding pixel electrode.

For example, the first thin film transistor 121 is connected to the first gate line GL1 and the first data line DL1. Further, the first thin film transistor 121 is connected to the first pixel electrode 131. The second thin film transistor 122 is connected to the first gate line GL1 and the second data line DL2. Further, the second thin film transistor 122 is connected to the second pixel electrode 132. The third thin film transistor 123 is connected to the first gate line GL1 and the third data line DL3. Further, the third thin film transistor 123 is connected to the third pixel electrode 133.

In the present exemplary embodiment, since the first thin film transistor 121, the second thin film transistor 122, and the third thin film transistor 123 each have substantially the same structure and function, the first thin film transistor 121 will be described as a representative example.

The first thin film transistor 121 includes a gate electrode 121a extending from the first gate line GL1, a source electrode 121b arranged on the gate electrode 121a while extending from the first data line DL1, and a drain electrode 121c connected to the first pixel electrode 131.

The first pixel electrode 131 includes a transparent conductive material, such as Indium Zinc Oxide (IZO) or Indium Tin Oxide (ITO), and receives a pixel voltage from the first thin film transistor 121.

The array substrate 100 further includes a storage line SL for transmitting a common voltage, and a first storage electrode SE1 and a second storage electrode SE2 extending from the storage line SL. The storage line SL is arranged in the light blocking area BA while extending in the first direction D1. The first storage electrode SE1 and the second storage electrode SE2 are arranged in correspondence with the pixel area PA while extending in the second direction D2. The first storage electrode SE1 and the second storage electrode SE2 overlap with a pixel electrode, such as the first pixel electrode 131, in a corresponding pixel area PA.

The array substrate 100 further includes a gate insulating layer 141, a passivation layer 142, and an organic insulating layer 143. The gate insulating layer 141 is arranged on the first base substrate 110, on which the gate lines including the first gate line GL1 and the first storage electrode SE1 and the second storage electrode SE2 are arranged. The passivation layer 142 and the organic insulating layer 143 are sequentially arranged on the gate insulating layer 141, on which the data lines including the first data line DL1 are arranged. The pixel electrodes 131, 132, and 133 are arranged on the organic insulating layer 143.

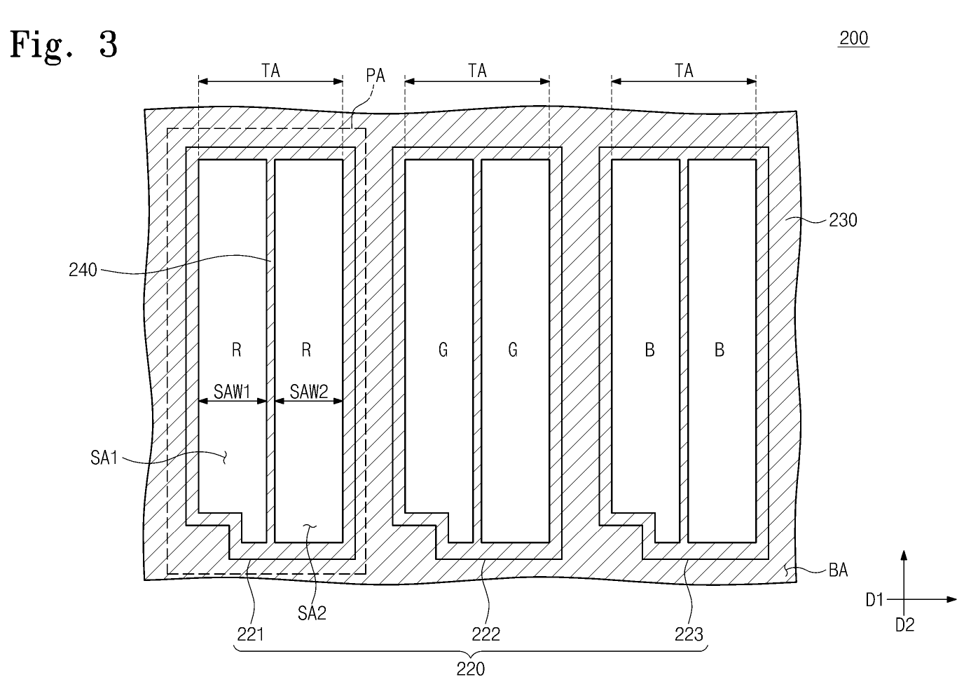

FIG. 3 is a plan view illustrating the color filter substrate shown in FIG. 2.

Referring to FIG. 2 and FIG. 3, the color filter substrate 200 faces the upper portion of the array substrate 100. The color filter substrate 200 includes a second base substrate 210, color filters 220, a first black matrix 230, a second black matrix 240, and a common electrode 260. Color filters 220 include individual color filters 221, 222, and 223.

The color filters 220, the first black matrix 230, and the second black matrix 240 are arranged on the lower surface of the second base substrate 210. Each color filter 221, 222, and 223 corresponds to a pixel area PA in a one-to-one fashion. Each color filter 221, 222, and 223 covers the light transmission area TA and filters out predetermined colors by using light incident to the light transmission area TA. As an example of the present exemplary embodiment, the color filters 220 may include a red color filter 221, a green color filter 222, and a blue color filter 223.

The first black matrix 230 corresponds to the light blocking area BA to block the light. Further, since the first black matrix 230 blocks light in the light blocking area BA, the first black matrix 230 may define the boundaries of the light transmission area TA. The first black matrix 230 includes metal materials or organic materials. The second black matrix 240 is arranged in the light transmission area TA to block the light. The second black matrix 240 extends in the second direction D2 and is connected to the first black matrix 230. The second black matrix 240 divides the light transmission area TA into a first sub-area SA1 and a second sub-area SA2, and the first sub-area SA1 and the second sub-area SA2 are arranged in the first direction D1. In the present exemplary embodiment, the first sub-area SA1 width SAW1 and the second sub-area SA2 width SAW2 may be substantially the same. However, in another exemplary embodiment, the first sub-area SA1 width SAW1 and the second sub-area SA2 width SAW2 may be different.

The second black matrix 240 may include the same material as the first black matrix 230, and may be formed in the same process of forming the first black matrix 230. For example, a thin film layer is formed on the second base substrate 210, and the thin film layer includes metallic materials or organic materials. When the thin film layer is patterned, the first black matrix 230 and the second black matrix 240 are formed on the second base substrate 210. In this embodiment, each color filter 220 is removed from an area in which the second black matrix 240 is arranged. However, in an alternate embodiment, the color filters 220 may be arranged in an area in which the second black matrix 240 is formed.

In the present exemplary embodiment, the second black matrix 240 may be arranged corresponding to one light transmission area TA. For example, if the second black matrix 240 is arranged corresponding to the green pixel only, the second black matrix 240 is arranged only in the light transmission area TA in which the green color filter 222 is arranged.

The color filter substrate 200 further includes an overcoat layer 250 covering the color filters 220, the first black matrix 230, and the second black matrix 240. The overcoat layer 250is arranged on the second base substrate 210 to planarize the color filter substrate 200. The common electrode 260 is arranged on the overcoat layer 250. The common electrode 260 includes a transparent conductive material, such as IZO or ITO, and receives the common voltage.

The liquid crystal layer 300 is interposed between the array substrate 100 and the color filter substrate 200. The liquid crystal layer 300 adjusts transmittance of the light according to a potential difference between the pixel voltage and the common voltage, and provides the adjusted light to the color filter substrate 200.

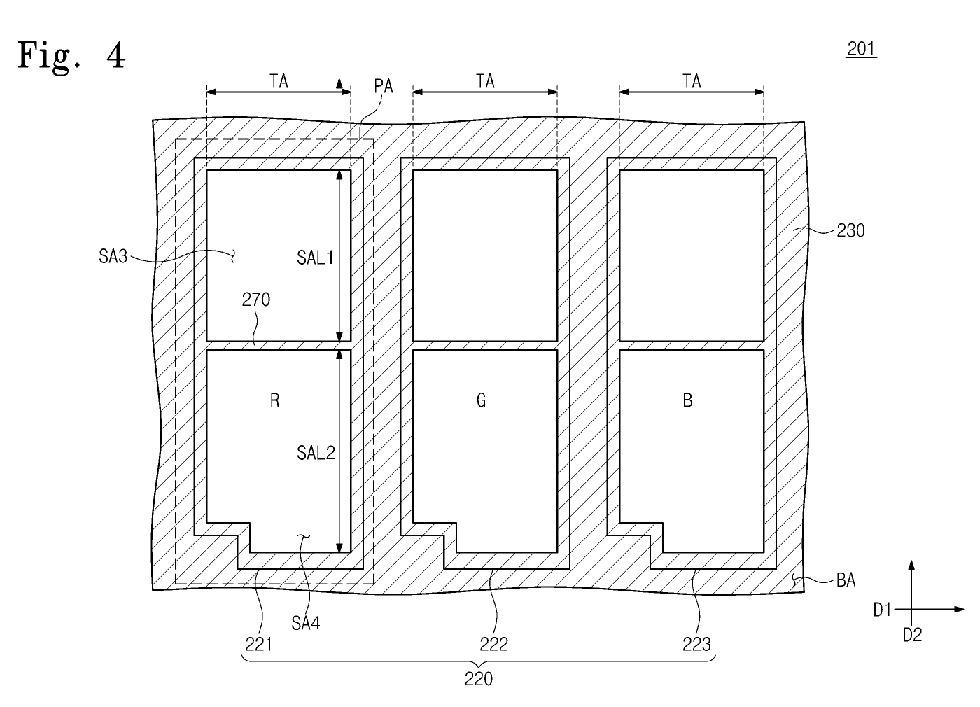

FIG. 4 is a plan view illustrating a color filter substrate according to another exemplary embodiment of the present invention.

Referring to FIG. 4, the color filter substrate 201 has substantially the same structure and function as the color filter substrate 200 shown in FIG. 3 except for a second black matrix 270. Thus, in FIG. 4, the same reference numerals denote the same or substantially similar elements as FIG. 3, and detailed descriptions of the same or substantially similar elements will be omitted.

The color filter substrate 201 includes a second base substrate 210, color filters 220 arranged on the second base substrate 210, a first black matrix 230 arranged on the second base substrate 210 in correspondence with a light blocking area BA, a second black matrix 270 arranged in a light transmission area TA, and a common electrode 260 for receiving a common voltage.

Each color filter 220 corresponds to a pixel area PA in a one-to-one fashion and produces a predetermined color of light. The first black matrix 230 blocks the light and surrounds the light transmission area TA.

The second black matrix 270 extends in the first direction D1 across a width of a pixel area PA, and is connected to the first black matrix 230. The second black matrix 270 divides the light transmission area TA into a third sub-area SA3 and a fourth sub-area SA4, and the third sub-area SA3 and the fourth sub-area SA4 are arranged in the second direction D2. In the present exemplary embodiment, the third sub-area SA3 length SAL1 and the fourth sub-area SA4 length SAL2 may be different. However, in another exemplary embodiment, the third sub-area SA3 length SAL1 and the fourth sub-area SA4 length SAL2 may be substantially the same.

The second black matrix 270 may be formed of the same material as that used to form the first black matrix 230, and may be formed using a process for forming the first black matrix 230.

In the present exemplary embodiment, the second black matrix 270 may be arranged corresponding to one light transmission area TA. For example, if the second black matrix 270 is arranged corresponding to the green color pixel only, the second black matrix 270 is arranged only in a light transmission area TA in which the green color filter 222 is arranged.

The color filter substrate 201 further includes an overcoat layer 250 that covers the color filters 220, the first black matrix 230, and the second black matrix 270 to planarize the color filter substrate 201. The common electrode 260 is arranged on the overcoat layer 250.

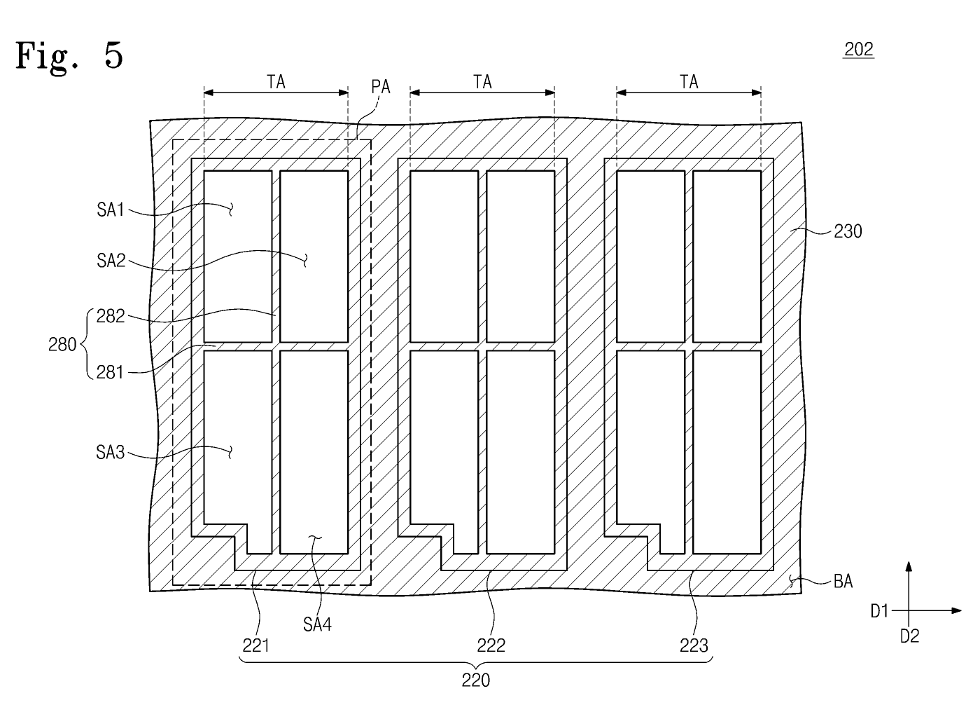

FIG. 5 is a plan view illustrating a color filter substrate according to another exemplary embodiment of the present invention.

Referring to FIG. 5, the color filter substrate 202 has substantially the same structure and function as the color filter substrate 200 shown in FIG. 3 except for a second black matrix 280. Thus, in FIG. 5, the same reference numerals denote the same or substantially similar elements as FIG. 3, and the detailed descriptions of the same or substantially similar elements will be omitted.

The color filter substrate 202 includes a second base substrate 210, color filters 220 arranged on the second base substrate 210, a first black matrix 230 arranged on the second base substrate 210 in correspondence with a light blocking area BA, a second black matrix 280 arranged in a light transmission area TA, and a common electrode 260 for receiving a common voltage.

Each color filter 220 corresponds to a pixel area PA in a one-to-one fashion and produces a predetermined color of light. The first black matrix 230 blocks the light and surrounds the light transmission area TA.

The second black matrix 280 includes a first light blocking line 28 land a second light blocking line 282, and blocks the light. The first light blocking line 281 extends in the first direction D1 across a width of the pixel area PA, and is connected to the first black matrix 230. The second light blocking line 282 extends in the second direction D2 across a length of the pixel area PA to cross with the first light blocking line 281, and is connected to the first black matrix 230. The first light blocking line 281 and the second light blocking line 282 divide the light transmission area TA into a first sub-area SA1, a second sub-area SA2, a third sub-area SA3, and a fourth sub-area SA4.

The second black matrix 280 may be formed of the same material used to form the first black matrix 230, and may be formed using a process for forming the first black matrix 230.

In the present exemplary embodiment, the second black matrix 280 may be arranged corresponding to one light transmission area TA. For example, if the second black matrix 280 is arranged corresponding to the green pixel only, the second black matrix 280 is arranged only in a light transmission area TA in which the green color filter 222 is arranged.

The color filter substrate 202 further includes an overcoat layer 250 that covers the color filters 220, the first black matrix 230, and the second black matrix 280 to planarize the color filter substrate 202. The common electrode 260 is arranged on the overcoat layer 250.

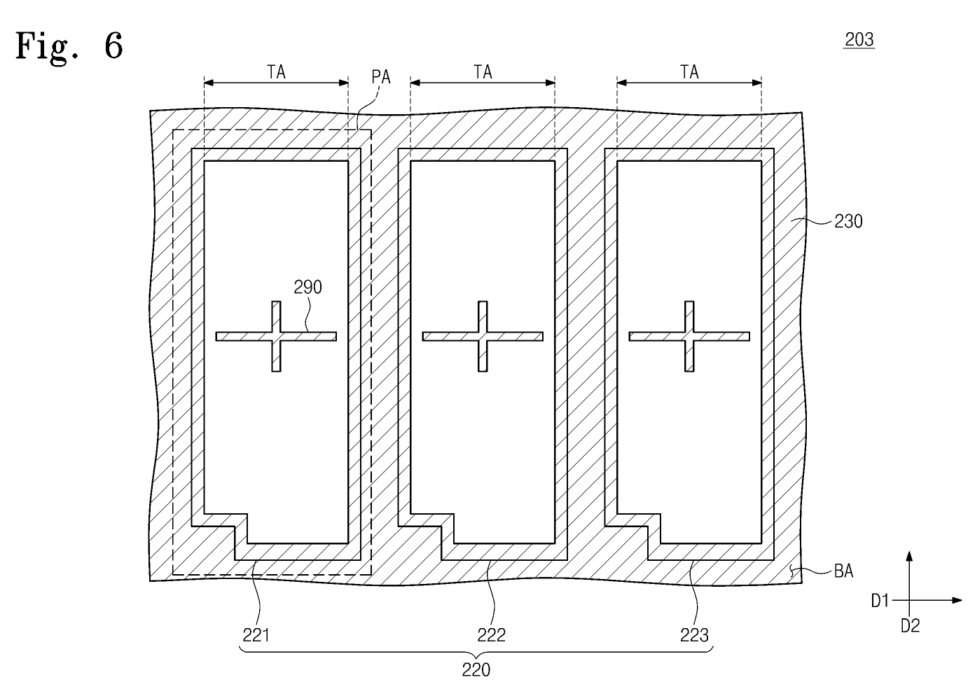

FIG. 6 is a plan view illustrating a color filter substrate according to another exemplary embodiment of the present invention.

Referring to FIG. 6, the color filter substrate 203 has substantially the same structure and function as the color filter substrate 200 shown in FIG. 3 except for a second black matrix 290. Thus, in FIG. 6, the same reference numerals denote the same or substantially similar elements as FIG. 3, and the detailed descriptions of the same or substantially similar elements will be omitted.

The color filter substrate 203 includes a second base substrate 210, color filters 220 arranged on the second base substrate 210, a first black matrix 230 arranged on the second base substrate 210 in correspondence with a light blocking area BA, a second black matrix 290 arranged in a light transmission area TA, and a common electrode 260 for receiving a common voltage.

Each color filter 220 corresponds to a pixel area PA in a one-to-one fashion and filters a predetermined color of light. The first black matrix 230 blocks the light and surrounds the light transmission area TA.

The second black matrix 290 has a cross shape and blocks the light. The second black matrix 290 is arranged in a central portion of the light transmission area TA to partially divide the light transmission area TA into two or more sub-areas. The second black matrix 290 may be formed of the same material used to form the first black matrix 230, and may be formed using a process for forming the first black matrix 230.

In the present exemplary embodiment, the second black matrix 290 may be arranged corresponding to one light transmission area TA. For example, if the second black matrix 290 is arranged corresponding to the green pixel only, the second black matrix 290 is arranged only in a light transmission area TA in which the green color pixel 222 is arranged.

The color filter substrate 203 further includes an overcoat layer 250 that covers the color filters 220, the first black matrix 230, and the second black matrix 290 to planarize the color filter substrate 203. The common electrode 260 is arranged on the overcoat layer 250.

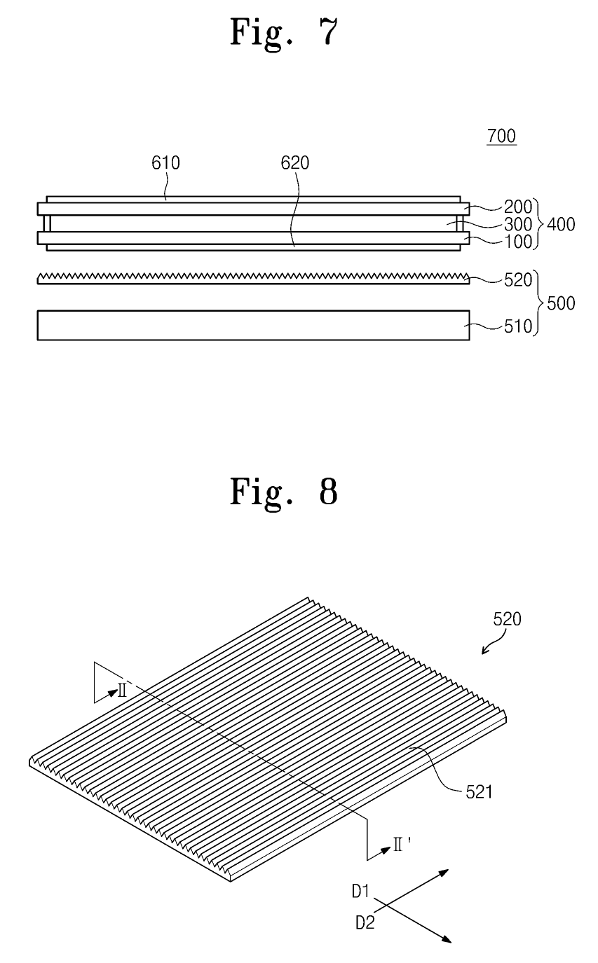

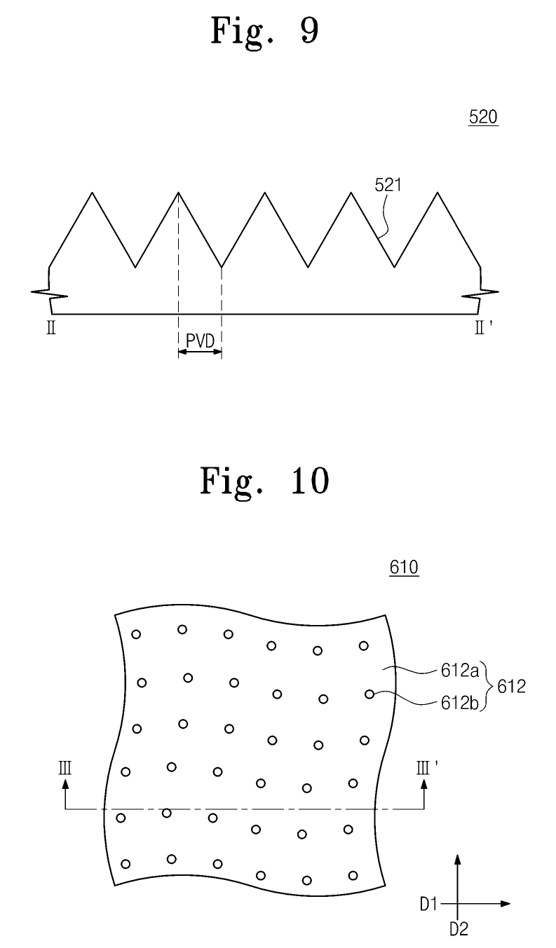

FIG. 7 is a section view illustrating a liquid crystal display apparatus having the liquid crystal display panel shown in FIG. 1, FIG. 8 is a perspective view illustrating the prism sheet shown in FIG. 7, and FIG. 9 is a section view taken along line II-II′ shown in FIG. 8.

Referring to FIG. 7, the liquid crystal display apparatus 700 includes the liquid crystal display panel 400 for displaying an image, a backlight assembly 500 for generating light, and a first polarizing plate 610 and a second polarizing plate 620 for polarizing light.

In FIG. 7, since the liquid crystal display panel 400 has the same or substantially similar structure and function as the liquid crystal display panel 400 shown in FIG. 1, the same reference numerals will be assigned to the same or substantially similar elements of the liquid crystal display panel 400, and the detailed descriptions of the same or substantially similar elements will be omitted.

Referring to FIG. 2 and FIG. 7, the liquid crystal display panel 400 includes the array substrate 100, the color filter substrate 200 facing the array substrate 100, and the liquid crystal layer 300 interposed between the array substrate 100 and the color filter substrate 200.

The color filter substrate 200 includes the second base substrate 210, the color filters 220, the first black matrix 230, the second black matrix 240, and the common electrode 260.

Each color filter 220 covers the light transmission area TA and produces predetermined colors by filtering the light incident to the light transmission area TA. The first black matrix 230 and the second black matrix 240 block the light. In detail, the first black matrix 230 is arranged corresponding to the light blocking area BA, and the second black matrix 240 is arranged in the light transmission area TA. The second black matrix 240 divides the light transmission area TA into at least two sub-areas as described for the exemplary embodiments above.

Referring to FIG. 7 and FIG. 8, the backlight assembly 500 is arranged under the liquid crystal display panel 400. The backlight assembly 500 includes a light source 510 for generating the light, and a prism sheet 520 interposed between the light source 510 and the liquid crystal display panel 400. The prism sheet 520 includes prisms 521 arranged on the upper surface thereof The prisms 521 may have triangular column shapes. The prisms 521 may be aligned adjacent to each other and focus the light output from the light source 510 towards the liquid crystal display panel 400. An area in which the light transmits from the prism sheet 520 corresponds to an area other than an area in which peaks and valleys are formed.

Referring to FIG. 3, FIG. 8, and FIG. 9, the prisms 521 may extend in the second direction D2, and may be arranged adjacent to each other in the first direction D1. The distance PVD between an adjacent peak and a valley may be different than the width SAW1 of the sub-area SA1 and the width SAW2 of the sub-area SA2. In the present exemplary embodiment, the distance PVD is narrower than the width SAW1 of the first sub-area SA1 and the width SAW2 of the second sub-area SA2.

Accordingly, an area in which the light is actually transmitted in the liquid crystal display panel 400 is arranged differently than an area in which the light is actually transmitted in the prism sheet 520. Consequently, the liquid crystal display apparatus 700 may minimize optical interference between the liquid crystal display panel 400 and the prism sheet 520, and may minimize the moire phenomenon and the defect in which certain pixels are observed as a white point, thereby improving the display quality.

In the present exemplary embodiment, the prisms 521 extend in the second direction D2, but may also extend in the first direction D1. In such a case, the liquid crystal display panel 400 may also include the color filter substrate 201 shown in FIG. 4. Referring to FIG. 4 and 8, the prisms 521 and the second black matrix 270 may extend in the first direction D1. The distance PVD between an adjacent peak and valley may be different than the length SAL1 of the third sub-area SA3 and the length SAL2 of the fourth sub-area SA4.

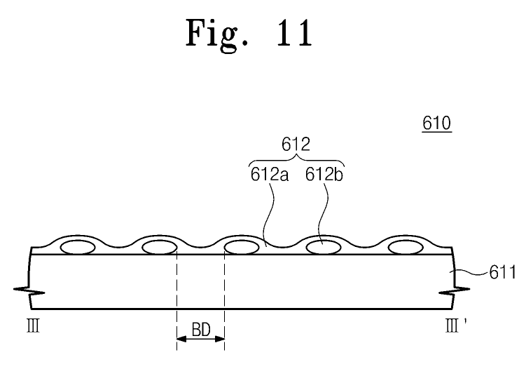

FIG. 10 is a plan view illustrating the first polarizing plate shown in FIG. 7, and FIG. 11 is a section view taken along line III-III′ shown in FIG. 10.

Referring to FIG. 7 and FIG. 10, the first polarizing plate 610 may be arranged on the upper surface of the liquid crystal display panel 400, and the second polarizing plate 620 may be arranged on the lower surface of the liquid crystal display panel 400. The first polarizing plate 610 polarizes the light from the liquid crystal display panel 400, and the second polarizing plate 620 polarizes the light from the backlight assembly 500. The polarizing direction of the second polarizing plate 620 may be substantially perpendicular to the polarization direction of the first polarizing plate 610.

Referring to FIG. 10 and FIG. 11, the first polarizing plate 610 includes a polarizing layer 611 for polarizing the light from the liquid crystal display panel 400, and an anti-reflective layer 612 arranged on the upper surface of the polarizing layer 611. The anti-reflective layer 612 may include a binder 612a and beads 612b dispersed in the binder 612a to reflect external light. Since the beads 612b may reflect both the external light and the light transmitted through the liquid crystal display panel 400, a region where the light from the liquid crystal display panel 400 is transmitted in the first polarizing plate 610 corresponds to an area where the beads 612b have not been formed.

Referring to FIG. 3, FIG. 10, and FIG. 11, a distance BD between two adjacent beads 612b in a direction in which the first sub-area SA1 and the second sub-area SA2 are arranged, i.e. in the first direction D1, may be different than the first sub-area SA1 width SAW1 and the second sub-area SA2 width SAW2. The first sub-area SA1 width SAW1 and the second sub-area SA2 width SAW2 may be narrower than the distance BD between two beads adjacent in the first direction D1.

Accordingly, an area in which the light is transmitted in the liquid crystal display panel 400 is different than an area in which light is transmitted in the first polarizing plate 610. Consequently, the liquid crystal display apparatus 700 may minimize the optical interference between the liquid crystal display panel 400 and the first polarizing plate 610, and may minimize the moire phenomenon and the defect in which certain pixels are observed as a white point, thereby improving the display quality.

In the present exemplary embodiment, the second black matrix 240 extends in the second direction D2. However, the second black matrix 270 may extend in the first direction D1, as shown in FIG. 4. In such a case, the third sub-area SA3 length SAL1 and the fourth sub-area SA4 length SAL2 divided by the second black matrix 270 may be different than a distance BD between two beads adjacent in the second direction D2.

According to the present invention, the liquid crystal display panel includes a second black matrix arranged in the light transmission area so that an area in which the light is blocked is defined in the light transmission area. Consequently, since the area in which the light transmits in the liquid crystal display panel is positioned different than the area in which the light transmits in the prism sheet, the optical interference between the liquid crystal display panel and the prism sheet may be minimized, and the moiré phenomenon and the defect in which certain pixels are observed as a white point may be minimized, thereby improving the display quality.

In addition, the area in which the light transmits in the liquid crystal display panel is positioned different than the area in which the light transmits in the first polarizing plate arranged on the upper surface of the liquid crystal display panel. Consequently, the optical interference between the liquid crystal display panel and the first polarizing plate may be minimized, and the moiré phenomenon and the defect in which certain pixels are observed as a white point may be minimized, thereby improving the display quality.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display panel, comprising:
a substrate comprising a plurality of pixel areas, each pixel area comprising a light transmission area and a light blocking area;
a color filter arranged in the pixel area;
a first black matrix arranged in the light blocking area to block the light; and
a second black matrix arranged in the light transmission area to block the light, the second black matrix dividing the light transmission area into at least two sub-areas.

2. The display panel of claim 1, wherein the second black matrix comprises a material used to form the first black matrix, and is formed using a process for forming the first black matrix.

3. The display panel of claim 1, wherein the second black matrix extends along a length of the pixel area to divide the light transmission area into two sub-areas.

4. The display panel of claim 1, wherein the second black matrix extends along a width of the pixel area to divide the light transmission area into two sub-areas.

5. The display panel of claim 1, wherein the second black matrix comprises:
a first light blocking line extending along a width of the pixel area; and
a second light blocking line extending along a length of the pixel area and crossing with the first light blocking line.

6. The display panel of claim 5, wherein the second black matrix divides the light transmission area into four sub-areas.

7. The display panel of claim 1, wherein the second black matrix has a cross shape.

8. The display panel of claim 1, wherein the second black matrix is connected to the first black matrix.

9. The display panel of claim 1, wherein the color filter corresponds to the pixel area in a one-to-one fashion, and comprises a red color filter, a green color filter, or a blue color filter.

10. The display panel of claim 9, wherein the color filter is arranged in the light transmission area, and the second black matrix corresponds to the color filter.

11. The display panel of claim 1, wherein the color filter comprises a first color filter portion and a second color filter portion, the first color filter portion being separated from the second color filter portion in the pixel area by the second black matrix.

12. A display apparatus, comprising:
a display panel to display an image using a light; and
a backlight assembly to provide the light to the display panel,
wherein the display panel comprises:
a substrate comprising a plurality of pixel areas, each pixel area comprising a light transmission area and a light blocking area;
a color filter arranged in the pixel area;
a first black matrix arranged in the light blocking area to block the light; and
a second black matrix arranged in the light transmission area to block the light, the second black matrix dividing the light transmission area into at least two sub-areas.

13. The display apparatus of claim 12, wherein the backlight assembly comprises:
a light source to generate the light; and
a prism sheet to focus the light towards the display panel.

14. The display apparatus of claim 13, wherein the prism sheet comprises a plurality of prisms arranged adjacent to each other.

15. The display apparatus of claim 14, wherein the second black matrix and the prisms extend along a length of the pixel area, and widths of the sub-areas are different than a distance between a peak and a valley of adjacent prisms.

16. The display apparatus of claim 14, wherein the second black matrix and the prisms extend along a width of the pixel area, and lengths of the sub-areas are different than a distance between a peak and a valley of adjacent prisms.

17. The display apparatus of claim 13, further comprising:
a polarizing member comprising a polarizing layer and an anti-reflective layer,
wherein the polarizing layer is arranged on the display panel to polarize the light from the display panel, the anti-reflective layer is arranged on the polarizing layer to prevent scattered reflection of the light incident from an exterior, and the anti-reflective layer comprises a binder covering the polarizing layer and a plurality of beads dispersed in the binder.

18. The display apparatus of claim 17, wherein the second black matrix extends along a length of the pixel area, and widths of the sub-areas are different than a distance between two adjacent beads arranged along a width of the pixel area.

19. The display apparatus of claim 17, wherein the second black matrix extends along a width of the pixel area, and lengths of the sub-areas are different than a distance between two adjacent beads arranged along a length of the pixel area.

20. A liquid crystal display (LCD) apparatus, comprising:
an LCD panel;
a first polarizing member arranged on a first surface of the LCD panel;
a second polarizing member arranged on a second surface of the LCD panel; and
a backlight assembly comprising a light source and a prism sheet,
wherein the LCD panel comprises:
an array substrate comprising a gate line, a data line, and a thin film transistor connected to the gate line and the data line to provide a pixel voltage to a pixel electrode;
an opposite substrate coupled to the array substrate, the opposite substrate comprising a common electrode and a pixel area, the pixel area comprising a light transmission area and a light blocking area;
a liquid crystal layer interposed between the array substrate and the opposite substrate;
a color filter arranged in the light transmission area, the color filter comprising a red color filter, a green color filter, or a blue color filter;
a first black matrix surrounding the color filter and arranged in the light blocking area to block the light; and
a second black matrix arranged in the light transmission area to block the light, the second black matrix dividing the light transmission area into a first sub-area and a second sub-area.
